(19) United States
(12) Patent Application Publication
(10) Pub. No.: US 2009/0046711 A1
(43) Pub. Date: Feb. 19, 2009

(54) Data rate adaptation enhancement

(75) Inventor: Jani Poikela, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/893,363

(22) Filed: Aug. 14, 2007

(51) Int. Cl. H04L 12/56

(52) U.S. Cl. 370/389

(57) ABSTRACT

The present invention provides a new and unique method or apparatus for checking if a next packet to be sent from a transmission buffer exceeds a predetermined threshold size when changing from a first mode to a second mode, for example, after a node, point, terminal or device in a wireless communications technology, such as a wireless local area network (WLAN), Worldwide Interoperability for Microwave Access Forum (WiMAX), Ultra Wide-Band (UWB), or other suitable network, enters into an active mode from an idle mode; and if so, then instead of the next packet transmitting a special first packet that is shorter than the next packet. The special first packet may include either a fragment of a longer packet on the transmission buffer or a null packet generated to probe a transmission link.

The present invention relates to a wireless communications technology, such as, for example, a wireless local area network (WLAN), Worldwide Interoperability for Microwave Access Forum (WiMAX), Ultra Wide-Band (UWB), Bluetooth (BT), cellular communication networks like Global System for Mobile Communications (GSM) or Universal Mobile Telecommunications System (UMTS) or any other suitable communications technology.

More particularly, the present invention relates to a new technique for data rate adaptation in a wireless communication technology enabled node, point terminal or device, including for example a two-part WLAN radio module implementation with a WLAN radio modem chipset in combination with a WLAN host subsystem, that wants to actively communicate in a WLAN network after a mode change.

In some wireless communication technology systems the transmission data rate is controlled from a host processor, or a chipset, or both. With a lower data rate, the probability of successful transmission is generally higher. Finding the optimal transmission rate in changing channel conditions is a challenge, especially if a power save mode is used and there are longer periods with no actual channel condition information available (for example through receptions of acknowledgments or beacons).

The conditions in a wireless communication system environment can change depending on the location of the device and other changes in the surrounding area. If the conditions on the environment have changed it is not very simple for the device to choose a correct rate for communicating with the network. Currently, existing solutions for data rate adaptation deal only with the selection of the data rate, but in the case of when the next packet to be sent in the transmission buffer is substantially long and the selected data rate is either very low, or the sent packet is not received correctly by an access point due to a too high data rate, the operational efficiency of the whole network decreases.

Some communication technology systems like WLAN rely on power save methods to preserve battery life. For this purpose the terminals switch to a power save/idle state. When changing back to an active state for data transmission the optimal data rate needs to be determined for the current environment.

In view of this, there is a need in the art for a method, apparatus, system and/or technique in which a node, point, terminal or device for improving rate adaptation when resuming active communication after entering an active mode from a power save/idle state.

The present invention provides a new and unique method and apparatus for checking if a next packet to be sent from a transmission buffer exceeds a predetermined threshold size when changing from a first mode to a second mode, for example, after a node, point, terminal or device in a wireless communications technology, such as a wireless local area network (WLAN), Worldwide Interoperability for Microwave Access Forum (WiMAX), Ultra Wide-Band (UWB), Bluetooth (BT), cellular communication networks like Global System for Mobile Communications (GSM) or Universal Mobile Telecommunications System (UMTS) or other suitable network, enters into a second mode form a first mode, for example, an active mode from an idle mode; and if so, then transmitting, instead of the next packet, a special first packet that is shorter than the next packet.

In effect, the invention provides a new technique to check, before initiating transmission of a first packet, the size of the first packet, and if the size exceeds the predetermined threshold size, the first packet is either fragmented to a substantially smaller packet, or a complete shorter packet on the transmission buffer is sent, or a dedicated probe packet, such as a null packet, is generated and sent to probe a transmission link. The whole thrust of the invention is that the first packet sent to the network after entering a second mode from a first mode for example an active mode from a power save/idle state is a smaller packet than the next packet that would have otherwise been transmitted.

The special first packet may also include a fragment of any other longer packet on the transmission buffer, and the null packet may contain no data.

The method also features adjusting the transmission rate of a transmission link based on information received in response to the special first packet transmitted.

The scope of the invention may also include any node, point, terminal or device that forms part of any wireless communications technology, including a WLAN, WiMAX, UWB, BT, cellular communication networks like GSM or UMTS or other suitable network, such as IEEE 802.XX technologies having a similar two-part implementation. In a WLAN system, the node, point, terminal or device may include a station or other suitable network node, point, terminal or device. Moreover, the scope of the invention may include implementing the same in either a WLAN radio modem chipset, a host processor, or some combination thereof, in such a node, point, terminal or device in such a wireless local area network or other suitable network.

By way of example, according to some embodiments of the present invention, the node, point, terminal or device may take the form of a WLAN enable device having a two-part wireless communication module implementation with a radio modem chipset and a host processor, as well as some other suitable two-part module implementation either now known or later developed in the future. In such a case, signalling may be exchanged between the radio modem chipset and the host processor that include a request for checking if the next packet to be sent from the transmission buffer exceeds the predetermined threshold size after the node, point, terminal or device enters into a second mode from a first mode, for example, entering an active mode from an idle mode.

By way of example, according to some embodiments of the present invention, the first frame to be transmitted is fragmented to smaller pieces with a higher probability of success and a lower overhead of slow transmission, the extreme being that the first medium access control frame actually contains no data, so it is a null frame. The success/failure of this smaller first frame causes smaller overhead in the retransmission or too slow rate selection than the possibly very long frame that is first in the queue. Another option, instead of fragmentation, is to select from the transmission buffers a small frame that would be used as the special first frame.

In operation, the WLAN host processor may know what is going on with the transmissions. When the WLAN host processor sees that there should be a transmission after, for example, a longer idle period, it may decide to use the special first frame. If there is a small frame already waiting for transmission, it may send it as the special first frame, or when all frames are long it may fragment the first frame to smaller pieces (fragments) that will be sent as the special first frame. The frames would be acknowledged by the receiver upon successful reception, and then the rate can be adjusted up or down more quickly with whatever methods that are used already in the art.

In effect, instead of sending Request-To-Send (RTS)/Clear-To-Send (CTS) with a fixed slow rate specified in the presently known for example in the IEEE 802.11 standards, or a long packet being sent with too slow or high rate, which both lead to excess battery consumption, some (or no data) can be sent with a desired rate but with a higher probability of success according to the present invention.

According to one example of the present invention, the method also features receiving the special first packet in another node, point, terminal or device in the wireless communications technology and providing a response that will enable the node, point, terminal or device to adjust the transmission rate of a transmission link. In particular, a corresponding method may feature steps of receiving a special first packet in a first node, point, terminal or device in a wireless communications technology, the special first packet being transmitted after a second node, point, terminal or device in the wireless communications technology entered into a second mode from a first mode like an active mode from an idle mode, checked if a next packet to be sent from a transmission buffer exceeded a predetermined threshold size, and, if so, then transmitted, instead of sending the next packet, the special first packet that is shorter than the next packet; and providing a response, such as an acknowledgement, that will enable the second node, point, terminal or device to adjust the transmission rate of a transmission link.

The apparatus may take the form of such a node, point, terminal or device featuring a first chipset module configured for checking if a next packet to be sent from a transmission buffer exceeds a predetermined threshold size, after the node, point, terminal or device in a wireless communications technology enters into a second mode from a first mode for example an active mode from an idle mode, and a second chipset module configured for transmitting, instead of the next packet, a special first packet that is shorter than the next packet if the next packet exceeds the predetermined threshold size, consistent with that described above. Alternatively, the apparatus may take the form of a corresponding node, point, terminal or device featuring a corresponding first chipset module configured for receiving a special first packet in the node, point, terminal or device in a wireless communications technology, the special first packet being transmitted after a second node, point, terminal or device in the wireless communications technology entered into a second mode from a first mode, checked if a next packet to be sent from a transmission buffer exceeded a predetermined threshold size, and, if so, then transmitted, instead of sending the next packet, the special first packet that is shorter than the next packet; and a corresponding second chipset module configured for providing a response, such as an acknowledgement, that will enable the second node, point, terminal or device to adjust the transmission rate of a transmission link, consistent with that described above.

According to one example of the present invention, the apparatus may also take the form of a chipset featuring a first chipset module configured for checking if a next packet to be sent from a transmission buffer exceeds a predetermined threshold size, after the node, point, terminal or device in a wireless communications technology enters into a second mode from a first mode; and a second chipset module configured for transmitting, instead of the next packet, a special first packet that is shorter than the next packet if the next packet exceeds the predetermined threshold size. Alternatively, the apparatus may also take the form of a corresponding chipset featuring a corresponding first chipset module configured for receiving a special first packet in the node, point, terminal or device in a wireless communications technology, the special first packet being transmitted after a second node, point, terminal or device in the wireless communications technology entered into a second mode from a first mode, checked if a next packet to be sent from a transmission buffer exceeded a predetermined threshold size, and, if so, then transmitted, instead of sending the next packet, the special first packet that is shorter than the next packet; and a corresponding second chipset module configured for providing a response, such as an acknowledgement, that will enable the second node, point, terminal or device to adjust the transmission rate of a transmission link.

The apparatus may also take the form of a computer program product with a program code, which program code is stored on a machine readable medium, for carrying out the steps of a method comprising checking if a next packet to be sent from a transmission buffer exceeds a predetermined threshold size after a node, point, terminal or device in a wireless communications technology enters into a second mode from a first mode; and if so, then transmitting, instead of the next packet, a special first packet that is shorter than the next packet, when the computer program is run in a module of either a node, point, terminal or device, such as a station, an access point, or other suitable node, point, terminal or device. Alternatively, the apparatus may also take the form of a corresponding computer program product with a program code, which program code is stored on a machine readable medium, for carrying out the steps of a method comprising receiving a special first packet in a first node, point, terminal or device in a wireless communications technology, the special first packet being transmitted after a second node, point, terminal or device in the wireless communications technology entered into a second mode from a first mode, checked if a next packet to be sent from a transmission buffer exceeded a predetermined threshold size, and, if so, then transmitted, instead of sending the next packet, the special first packet that is shorter than the next packet, and providing a response, such as an acknowledgement, that will enable the second node, point, terminal or device to adjust the transmission rate of a transmission link, when the computer program is run in a module of either a node, point, terminal or device, such as a station, an access point, or other suitable node, point, terminal or device.

The apparatus may also take the form of a combination of means for checking if a next packet to be sent from a transmission buffer exceeds a predetermined threshold size, after the node, point, terminal or device in a wireless communications technology enters into a second mode from a first mode, together with means for transmitting, instead of the next packet, a special first packet that is shorter than the next packet if the next packet exceeds the predetermined threshold size.

The scope of the invention is not intended to be limited to the partitioning of the functionality between the radio modem chipset and the host processor chipset. For example, according to some embodiments of the present invention, the radio modem chipset may only be responsible for the data transmission and all the control logic may be located in the host processor chipset.

The drawing includes the following Figures, which are not necessarily drawn to scale:

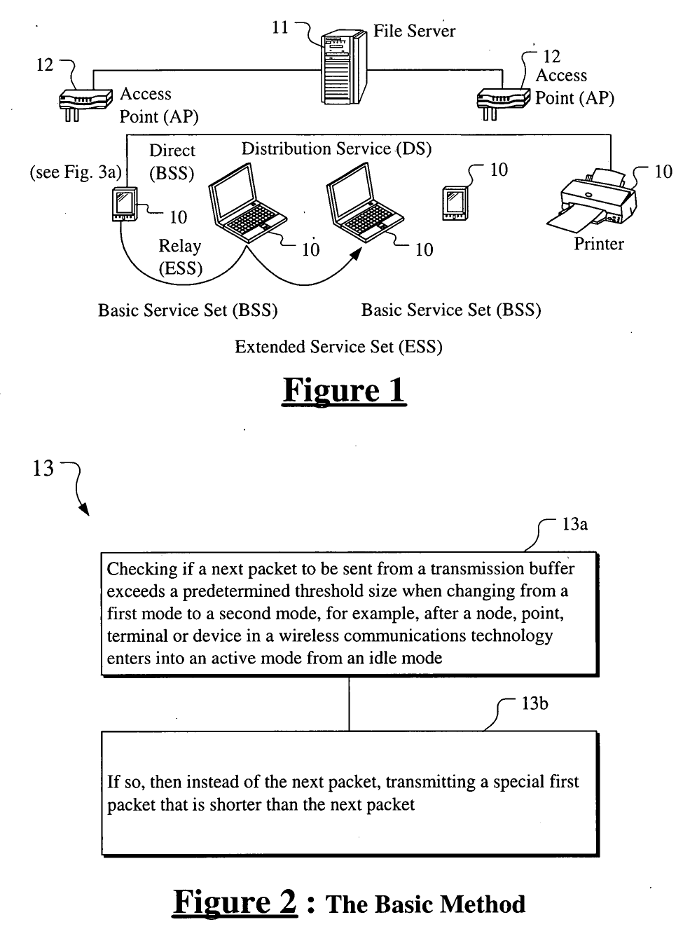

FIG. 1 shows typical parts of an IEEE 802.11 WLAN system according to some embodiments of the present invention.

FIG. 2 shows a flowchart of the basic steps of the method for the chipset according to some embodiments of the present invention.

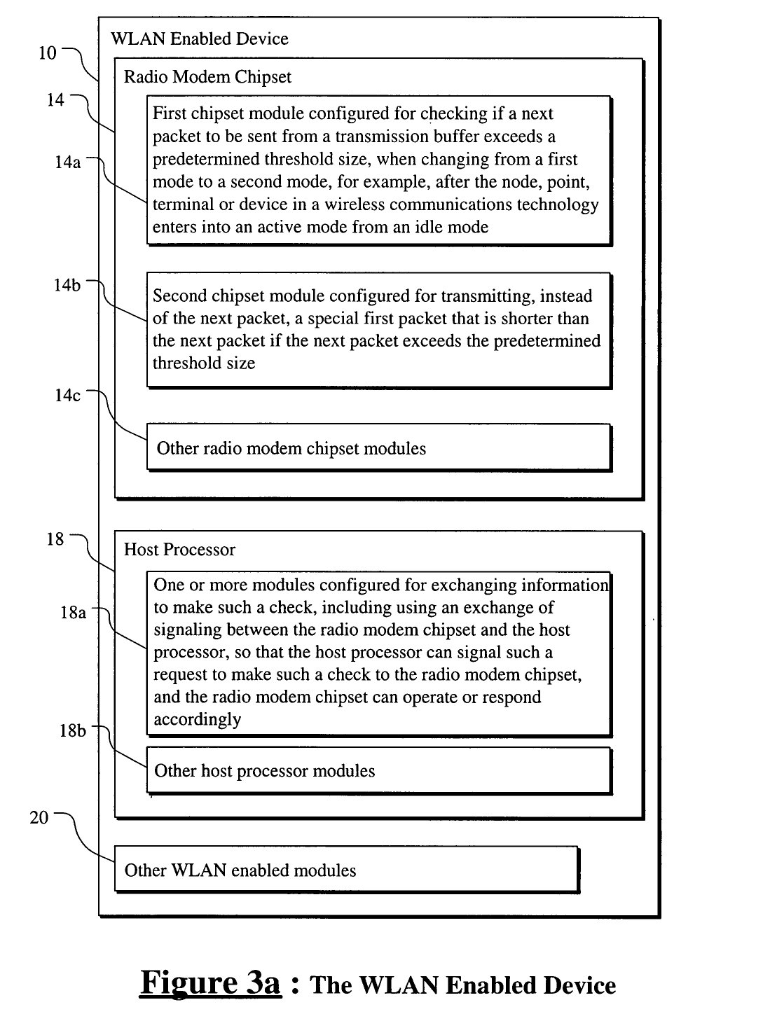

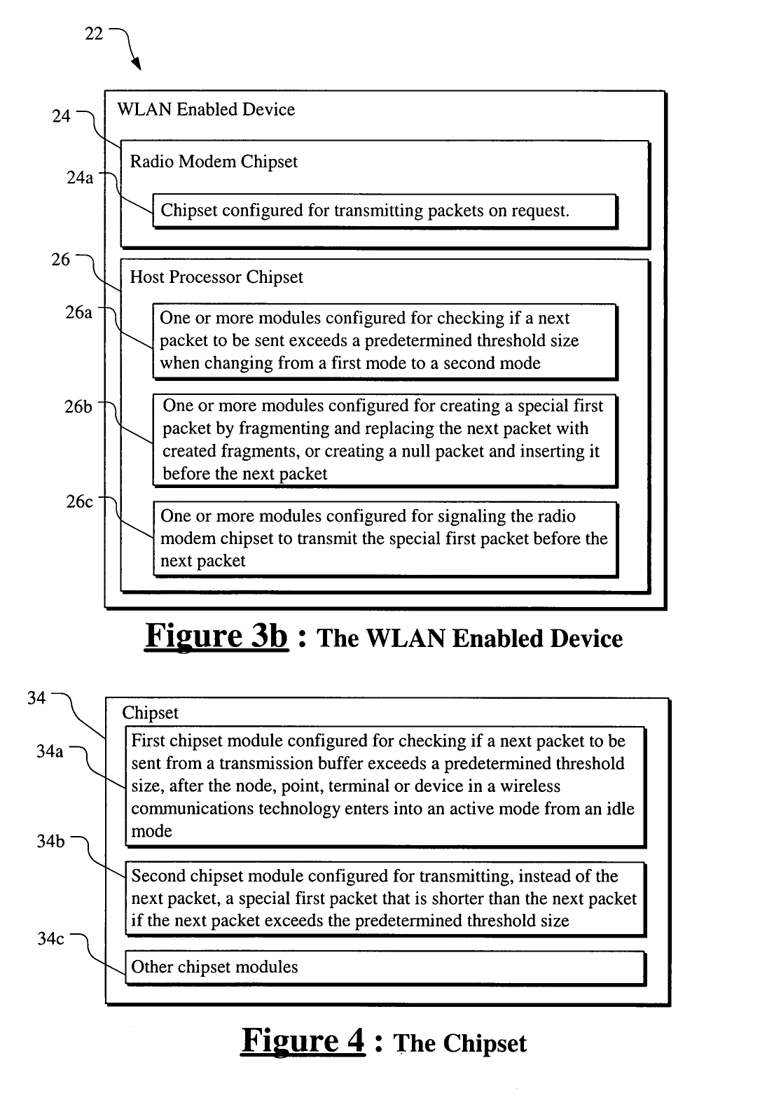

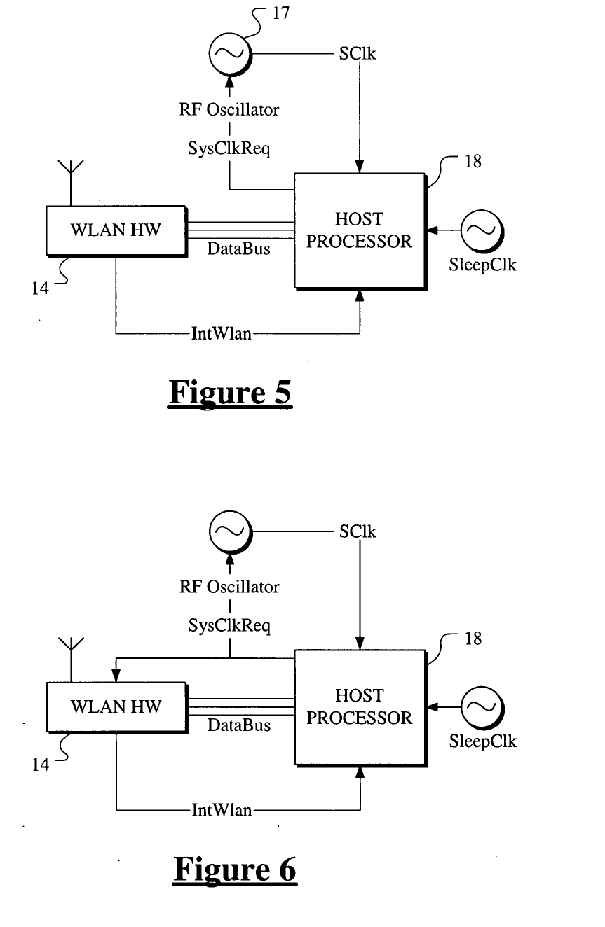

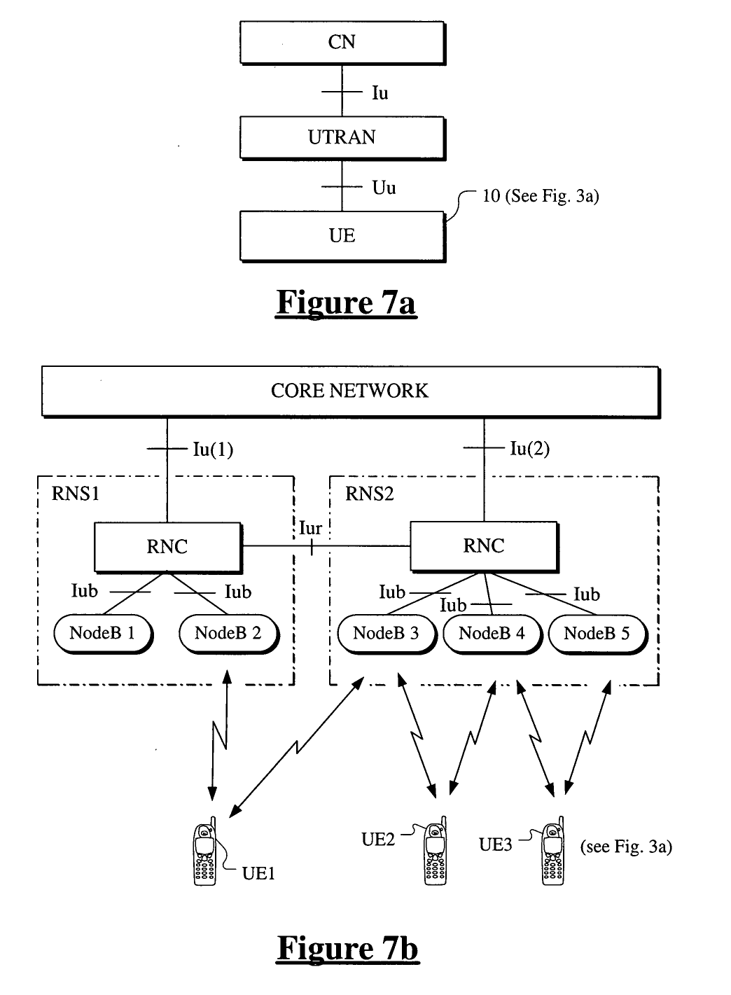

FIG. 3a shows a WLAN enabled device that forms part of the WLAN shown in FIG. 1 according to some embodiments of the present invention.

FIG. 3b shows a WLAN enabled device that forms part of the WLAN shown in FIG. 1 according to some embodiments of the present invention.

FIG. 4 shows a chipset that forms part of any wireless communications technology according to some embodiments of the present invention.

FIG. 5 shows a diagram of a simplified WLAN device system according to some embodiments of the present invention.

FIG. 6 shows a diagram of a modified WLAN device system according to some embodiments of the present invention.

FIGS. 7a and 7b show diagrams of the Universal Mobile Telecommunications System (UMTS) packet network architecture according to some embodiments of the present invention.

FIG. 1 shows, by way of example, typical parts of an IEEE 802.11 WLAN system, according to one example of the present invention, and provides for communications between communications equipment such as mobile and secondary devices including personal digital assistants (PDAs), laptops and printers, etc. The WLAN system may be connected to a wired LAN system that allows wireless nodes, points, terminals or devices such as 10 to access information and files on a file server or other suitable device 11 or connecting to the Internet.

The devices can communicate directly with each other in the absence of a base station in a so-called “ad-hoc” mode, or they can communicate through a base station, in a so-called “infrastructure” mode, called an Access Point (AP) such as 12 in IEEE 802.11 terminology, with distributed services through the AP using local distributed services or wide area extended services, as shown. In a WLAN system, end user access modes, points, terminals or devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs 10 may take various forms ranging from wireless network interface card (NIC) adapters coupled to devices to integrated radio modules that are part of the devices, as well as an external adapter, a PCMCIA card or a USB Dongle (self contained), which are all typical devices known in the art. The scope of the invention is not intended to be limited to implementing the same in any such device.

Although the present invention is described in relation to a wireless local area network shown in FIG. 1, the present invention is also applicable to other suitable wireless communications technologies, such as, for example, WiMAX, UWB and/or BT technologies, as well as other suitable network technologies either now known or later developed in the future, including the Universal Mobile Telecommunications System (UMTS) Packet Network Architecture shown in FIGS. 7a and 7b.

FIG. 2 shows a flowchart generally indicated as 13 with basic steps 13a, 13b of a method according to some embodiments of the present invention, including steps for checking if a next packet to be sent from a transmission buffer exceeds a predetermined threshold size when changing from a first mode to a second mode, for example, after a node, point, terminal or device such as 10 (FIG. 1) in the wireless local area network in FIG. 1, enters into an active mode from an idle mode; and if so, then transmitting, instead of the next packet, a special first packet that is shorter than the next packet. The scope of the invention is intended to include implementing the same in other wireless communications technology, such as WiMAX, UWB, or other suitable network discussed herein. In effect, the present invention provides a new technique to check, while initiating transmission of a first packet, the size of the first packet, and if it exceeds the predetermined threshold size, the packet is either fragmented to a substantially smaller packet, or a complete shorter packet on the transmission buffer is sent, or a dedicated probe packet, such as a null packet, is generated and sent to probe a transmission link. By way of a specific example, the whole thrust of the present invention is that the first packet sent by the STA 10 to the AP 12 or by the AP to the STA in the WLAN network in FIG. 1 after entering the active mode from the power save/idle state is a smaller packet than the next one that otherwise would have been transmitted.

It should be noted that the predetermined threshold value might depend on the previous operation mode of the AP or the STA like for example the last used data rate before the mode change. For example, in one embodiment different predetermined threshold values are defined for each supported data rate or different values are defined for groups of data rates.

In effect, the scope of the invention is intended to include the WLAN enabled device 10 taking the form of not only a station shown in FIG. 1, but also an access point 12 or other suitable node, point, terminal or device either now known or later developed in the future for operating in such a wireless local area network or other suitable network such as that shown in FIG. 1, as well as FIGS. 7a and/or 7b discussed below. In addition, for the purpose of describing the instant invention, the special first packet is provided by the WLAN enabled device 10 to the access point 12 in the WLAN network; however, the scope of the invention is not intended to be limited to the type or kind of node, point, terminal or device where such a special first packet is provided or received.

In particular, FIG. 3a shows a node, point, terminal or device according to a non-limiting embodiment of the present invention in the form of a WLAN enabled device 10 (e.g. STA 10) according for a wireless local area network or other suitable network such as that shown in FIG. 1, as well as FIGS. 7a and/or 7b consistent with that discussed below. For the purpose of this discussion, the WLAN enabled device 10 is described as having a two-part implementation with a WLAN radio modem chipset 14 in combination with a host processor 18, although the present invention is not intended to be limited to such an implementation.

The WLAN radio modem chipset 14 includes a first chipset module 14a configured for checking if a next packet to be sent from a transmission buffer exceeds a predetermined threshold size, when changing from a first mode to a second mode, for example, after the node, point, terminal or device 10 in the WLAN in FIG. 1 enters into an active mode from an idle mode, and a second chipset module 14b coupled with the first chipset module 14a and configured for transmitting, instead of the next packet, a special first packet that is shorter than the next packet if the next packet exceeds the predetermined threshold size. The WLAN radio modem chipset 14 may also include other radio modem chipset modules 14c that perform functions that do not form part of the underlying invention disclosed herein, and thus are not described in detail herein.

The host processor 18 has one or more modules 18a configured for exchanging information to make such a check. In operation, the present invention is implemented using such an exchange of signaling between the WLAN radio modem chipset 14 and the host processor 18, so that the host processor 18 can signal such a request to make such a check to the WLAN radio modem chipset 14, and the WLAN radio modem chipset 14 can operate or respond accordingly, consistent with that shown and described herein. The host processor 18 may also include other host processor modules 18b that perform functions that do not form part of the underlying invention disclosed herein, and thus are not described in detail herein.

By way of example, the present invention is described with the chipset performing the checking functionality in response to some signaling exchange with the host processor in the node, point, terminal or device according to the present invention. However, it is important to note that the scope of the invention is not intended to be limited to where, or in which module, any such functionality needed to implement the present invention is implemented in the node, point, terminal or device according to the present invention. For example, embodiments are envisioned in which the host processor performs one or more parts of such functionality within the spirit and scope of the present invention. Moreover, embodiments are envisioned in which the checking functionality is performed automatically after each transition after entering, for example, from the active mode to the idle mode, as well as selectively or checking after some transitions from the idle mode to the active mode, for example, based on the evaluation of some parameter, including but not limited to, the length of time the WLAN enabled device in the idle mode, as well as some other parameter either now known or later developed in the future.

The WLAN enabled device 10 may also have other WLAN enabled modules 20 that are known in the art and do not form part of the underlying invention disclosed herein, and thus are not described in detail herein.

Alternatively, FIG. 3b shows a WLAN enabled device generally indicated as 22 that may also form part of the WLAN shown in FIG. 1 according to some embodiments of the present invention that includes a radio modem chipset 24 and a host processor 26. The radio modem chipset 24 includes one or more modules 24a configured for transmitting packets on request. The host processor 26 includes one or more modules 26a configured for checking if a next packet to be sent exceeds a predetermined threshold size when changing from a first mode to a second mode; one or more modules 26b configured for creating the special first packet by fragmenting and replacing the next packet with created fragments, or creating a null packet and inserting it before the next packet; and one or more modules 26c configured for signaling the radio modem chipset to transmit the special first packet before the next packet.

The exemplary embodiment of present invention is described in relation to a WLAN chipset for such a WLAN enabled node, point, terminal or device in such a WLAN or other suitable network, which typically may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

However, and in addition thereto, FIG. 4 shows, by way of example, a basic chipset module 34 for any node, point, terminal or device that may form part of any wireless communications technology discussed herein, which may include a first chipset module 34a and a second chipset module 34b with the basic functionality consistent with that described above, as well as one or more other chipset modules 34c that are known in the art and do not form part of the underlying invention disclosed herein, including e.g. a baseband module, a MAC module, a host interface module, and thus are not described in detail herein.

By way of example, and consistent with that described herein, the basic functionality of the modules 14a, 14b, 18a, 24a, 26a, 26b, 26c, 34a, or 34b may be configured and implemented using hardware, software, firmware, or a combination thereof, although the scope of the invention is not intended to be limited to any particular embodiment thereof. In a typical software implementation, the modules 14a, 14b, 18a, 24a, 26a, 26b, 26c, 34a, 34b would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 14a and 14b, or the module 18a, or modules 34a, 34b being configured as stand alone modules, as shown, or being configured in the combination with other circuitry for implementing another module.

The other WLAN enabled modules 14c, 18b and 20 and chipset modules 17 may also include other modules, circuits, devices that do not form part of the underlying invention per se. The functionality of the other modules, circuits, device that do not form part of the underlying invention are known in the art and are not described in detail herein.

FIG. 5 shows an exemplary and simplified WLAN device system having a basic two-part module implementation. In operation, when the host processor 18 is in a sleep mode only a sleep clock (SleepClk) is on so that the host processor 18 can wake itself up when external peripherals want to wake system up. For example, when the WLAN radio modem chipset (HW 14 on the figure) wants to wake the system up, it first raises the interrupt line (IntWlan) line, which causes the host processor 18 to enable the system clock request (SysClkReq) to get the main host processor 18 up running once the RF oscillator 17 is stabilized. Once the host processor 18 is fully ready, it processes the interrupt and pulls data from the WLAN HW 14. After processing, the host processor 18 will disable the clock request signal and enter back into a deep-sleep.

Alternatively, FIG. 6 shows a modified system that is similar to the system shown in FIG. 5, with an exception that the SysClkReq is connected to WLAN HW via general purpose I/O pin so that it can detect the state of the host processor's main clock and use the info to adjust its behavior. The scope of the invention is intended to include implementation is such a system, as well as other such systems either now known or later developed in the future.

The following provides a brief description on the benefit of adding the transmission of a very small frame (referred to herein as a ChannelProbe frame or a special first packet or frame) in front of a longer data frame on 802.11 modems. The ChannelProbe frame can be, for example, a standard 802.11 Null function frame, or a small standard data frame fragment. A ChannelProbe is not a new frame format, but a name for a specific small frame sent in the beginning of a transmission of a longer frame in order to get a channel estimate for example from an acknowledgment message sent as reply.

While this new method or technique according to the present invention may not have applicability of use with small frames, with large frames (like browsing and file transfer) and low to moderate bit rates (like VoIP applications) this new method or technique has benefits.

The scope of the invention is also intended to include implementing the same in relation to an Universal Mobile Telecommunications System (UMTS) packet network architecture, such as that shown in FIGS. 7a and 7b, which includes diagrams of the UMTS packet network architecture.

In FIG. 7a, the UMTS packet network architecture includes the major architectural elements of User Equipment (UE), UMTS Terrestrial Radio Access Network (UTRAN), and Core Network (CN). The UE is interfaced to the UTRAN over a radio (Uu) interface, while the UTRAN interfaces to the core network (CN) over a (wired) Iu interface, and would operate in a manner consistent with that shown and described above, including that shown in FIG. 3a and/or FIG. 3b.

FIG. 7b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 7a. A given UE may be in radio contact with multiple Node Bs even if one or more of the Node Bs are connected to different RNCs. For instance, a UE1 in FIG. 7b may be in radio contact with Node B2 of RNS1 and Node B3 of RNS2 where Node B2 and Node B3 are neighboring Node Bs. The RNCs of different RNSs may be connected by an lur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 7a and 7b has resulted in STAs taking the form of UEs, such as mobile phones or mobile terminals. The interworking of the WLAN shown in FIG. 1 with such other technologies (e.g. 3GPP, 3GPP2 or 802.16) such as that shown in FIGS. 7a and 7b is being defined at present in protocol specifications for 3GPP and 3GPP2.

Moreover still, the scope of the invention is intended to include expanding this implementation to any other kind of protocols. This method is also applicable for other 802 technologies such as 802.16e (WiMAX) and etc.

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

Even if the exemplary embodiment of the present invention is mainly described in the WLAN environment, it should be self-evident for a person skilled in the art that the exemplary description of the invention can be applied to other wireless communication technology systems.

Further, the invention might not only be applicable when a device changes from an active to an idle mode but for all changes like channel switching or system initialization that are requiring data rate adaptation.

What is claimed is:

1. A method comprising:
checking if a next packet to be sent exceeds a predetermined threshold size when changing from a first mode to a second mode; and
if so, then transmitting, instead of the next packet, a special first packet that is shorter than the next packet.

2. A method according to claim 1, wherein the special first packet includes either a complete shorter packet on a transmission buffer; or a fragment of any longer packet on the transmission buffer, including the next packet; or a dedicated probe packet, such as a null packet.

3. A method according to claim 2, wherein the null packet contains no data.

4. A method according to claim 1, wherein the method further comprises adjusting the transmission rate of a transmission link based on information received in response to the special first packet.

5. A method according to claim 1, wherein the node, point, terminal or device is a station or an access point in a wireless local area network.

6. A method according to claim 1, wherein the method further comprises:
receiving the special first packet in another node, point, terminal or device in a wireless communications technology; and
providing a response that will enable the node, point, terminal or device to adjust the transmission rate of a transmission link.

7. A method according to claim 1, wherein the node, point, terminal or device takes the form of a two-part wireless communication module implementation having a radio modem chipset and a host processor.

8. A node, point, terminal or device comprising:
a first chipset module configured for checking if a next packet to be sent exceeds a predetermined threshold size when changing from a first mode to a second mode; and
a second chipset module configured for transmitting, instead of the next packet, a special first packet that is shorter than the next packet if the next packet exceeds the predetermined threshold size.

9. A node, point, terminal or device according to claim 8, wherein the special first packet includes either a complete shorter packet on a transmission buffer; or a fragment of any longer packet on the transmission buffer, including the next packet; or a dedicated probe packet, such as a null packet.

10. A node, point, terminal or device according to claim 9, wherein either the longer packet is the next packet or any other packet in the transmission buffer, or the null packet contains no data.

11. A node, point, terminal or device according to claim 8, wherein the node, point, terminal or device further comprises a third chipset module configured for adjusting the transmission rate of a transmission link based on information received in response to the special first packet.

12. A node, point, terminal or device according to claim 8, wherein the node, point, terminal or device is a station or an access point in a wireless local area network.

13. A node, point, terminal or device according to claim 8, wherein the node, point, terminal or device takes the form of a two-part wireless communication module implementation having a radio modem chipset and a host processor.

14. A method comprising:
receiving a special first packet in a first node, point, terminal or device in a wireless communications technology, the special first packet being transmitted after a second node, point, terminal or device in the wireless communications technology entered in a second mode from a first mode checked if a next packet to be sent exceeded a predetermined threshold size, and, if so, then transmitted, instead of sending the next packet, the special first packet that is shorter than the next packet; and
providing a response that will enable the second node, point, terminal or device to adjust the transmission rate of a transmission link.

15. A method according to claim 14, wherein the special first packet includes either a complete shorter packet on a transmission buffer; or a fragment of any longer packet on the transmission buffer, including the next packet; or a dedicated probe packet, such as a null packet.

16. A method according to claim 15, wherein the null packet contains no data.

17. A method according to claim 14, wherein the node, point, terminal or device is a station or an access point in a wireless local area network.

18. A method according to claim 14, wherein the node, point, terminal or device takes the form of a two-part wireless communication module implementation having a radio modem chipset and a host processor.

19. A node, point, terminal or device comprising:
a first chipset module configured for receiving a special first packet in the node, point, terminal or device in a wireless communications technology, the special first packet being transmitted after a second node, point, terminal or device in the wireless communications technology entered in a second mode from a first mode, checked if a next packet to be sent exceeded a predetermined threshold size, and, if so, then transmitted, instead of sending the next packet, the special first packet that is shorter than the next packet; and
a second chipset module configured for providing a response that will enable the second node, point, terminal or device to adjust the transmission rate of a transmission link.

20. A node, point, terminal or device according to claim 19, wherein the special first packet includes either a complete shorter packet on a transmission buffer; or a fragment of any longer packet on the transmission buffer, including the next packet; or a dedicated probe packet, such as a null packet.

21. A node, point, terminal or device according to claim 20, wherein the null packet contains no data.

22. A node, point, terminal or device according to claim 19, wherein the node, point, terminal or device is a station or an access point in a wireless local area network.

23. A node, point, terminal or device according to claim 19, wherein the node, point, terminal or device takes the form of a two-part wireless communication module implementation having a radio modem chipset and a host processor.

24. A chipset comprising:
a first chipset module configured for checking if a next packet to be sent exceeds a predetermined threshold size, after a node, point, terminal or device in a wireless communications technology when changing from a first mode to a second mode; and
a second chipset module configured for transmitting, instead of the next packet, a special first packet that is shorter than the next packet if the next packet exceeds the predetermined threshold size.

25. A chipset according to claim 24, wherein the special first packet includes either a complete shorter packet on a transmission buffer; or a fragment of any longer packet on the transmission buffer, including the next packet; or a dedicated probe packet, such as a null packet.

26. A chipset according to claim 25, wherein the null packet contains no data.

27. A chipset according to claim 24, wherein the chipset further comprises a third chipset module configured for adjusting the transmission rate of a transmission link based on information received in response to the special first packet.

28. A chipset according to claim 24, wherein the node, point, terminal or device is a station or an access point in a wireless local area network.

29. A chipset according to claim 24, wherein the node, point, terminal or device takes the form of a two-part wireless communication module implementation having a radio modem chipset and a host processor.

30. A chipset comprising:
a first chipset module configured for receiving a special first packet in a node, point, terminal or device in a wireless communications technology, the special first packet being transmitted after a second node, point, terminal or device in the wireless communications technology entered into a second mode from an first mode, checked if a next packet to be sent exceeded a predetermined threshold size, and, if so, then transmitted, instead of sending the next packet, the special first packet that is shorter than the next packet; and
a second chipset module configured for providing a response that will enable the second node, point, terminal or device to adjust the transmission rate of a transmission link.

31. A chipset according to claim 30, wherein the special first packet includes either a complete shorter packet on a transmission buffer; or a fragment of any longer packet on the transmission buffer, including the next packet; or a dedicated probe packet, such as a null packet, generated to probe a transmission link.

32. A chipset according to claim 31, wherein the null packet contains no data.

33. A chipset according to claim 30, wherein the node, point, terminal or device is a station or an access point in a wireless local area network.

34. A chipset according to claim 30, wherein the node, point, terminal or device takes the form of a two-part wireless communication module implementation having a radio modem chipset and a host processor.

35. A computer program product with a program code, which program code is stored on a machine readable medium, for carrying out the steps of a method comprising checking if a next packet to be sent exceeds a predetermined threshold when changing from a first mode to a second mode; and if so, then transmitting, instead of the next packet, a special first packet that is shorter than the next packet, when the computer program is run in a module of either the node, point, terminal or device, such as a station, an access point, or other suitable node, point, terminal or device.

36. A computer program product with a program code, which program code is stored on a machine readable medium, for carrying out the steps of a method comprising receiving a special first packet in a first node, point, terminal or device in a wireless communications technology, the special first packet being transmitted after a second node, point, terminal or device in the wireless communications technology entered into a second mode from a first mode, checked if a next packet to be sent exceeded a predetermined threshold size, and, if so, then transmitted, instead of sending the next packet, the special first packet that is shorter than the next packet, and providing a response that will enable the second node, point, terminal or device to adjust the transmission rate of a transmission link, when the computer program is run in a module of either the first node, point, terminal or device, such as a station, an access point, or other suitable node, point, terminal or device.

37. A method according to claim 1, wherein the method further comprises implementing the step of the method via a computer program running in a processor, controller or other suitable module in one or more network nodes, points, terminals or elements in the wireless communications technology.

38. Apparatus comprising:
means for checking if a next packet to be sent exceeds a predetermined threshold size, when changing from a first mode to a second mode; and
means for transmitting, instead of the next packet, a special first packet that is shorter than the next packet if the next packet exceeds the predetermined threshold size.

39. A method according to claim 38, wherein the special first packet includes either a complete shorter packet on a transmission buffer, or a fragment of a longer packet on the transmission buffer, or a dedicated probe packet, such as a null packet, generated to probe a transmission link.

40. A method according to claim 7, wherein signalling between the radio modem chipset and the host processor includes a request for checking if the next packet to be sent from the transmission buffer exceeds the predetermined threshold size after the node, point, terminal or device enters into the second mode from the first mode.

41. A node, point, terminal or device according to claim 13, wherein signalling between the radio modem chipset and the host processor includes a request for checking if the next packet to be sent from the transmission buffer exceeds the predetermined threshold size after the node, point, terminal or device enters into the second mode from the first mode.

42. A chipset according to claim 29, wherein signalling between the radio modem chipset and the host processor includes a request for checking if the next packet to be sent from the transmission buffer exceeds the predetermined threshold size after the node, point, terminal or device enters into the second mode from the first mode.
